(19) United States
(12) Patent Application Publication
(10) Pub. No.: US 2003/0072871 A1
(43) Pub. Date: Apr. 17, 2003

(54) Process for producing weather resistant coating film

(76) Inventors: Takayoshi Yamazaki, Omiya-shi (JP); Takashi Sunamori, Funabashi-shi (JP)

Correspondence Address: MANELLI DENISON & SELTER, 2000 M STREET NW SUITE 700, WASHINGTON, DC, 20036-3307, US

(21) Appl. No.: 10/173,781

(22) Filed: Jun. 19, 2002

Related U.S. Application Data
(62) Division of application No. 09/864,278, filed on May 25, 2001.

(30) Foreign Application Priority Data
Nov. 15, 2000 (JP) 2000-348232

(51) Int. Cl. B05B 5/00

(52) U.S. Cl. 427/160

(57) ABSTRACT

A process for producing a weather resistant coating film which can keep a gloss retention of 80% or more for 1,000 hours or more in an accelerated weathering test by a carbon sunshine weather-o-meter by preparing a weather resistant coating material comprising a binder and a curing agent as main constituents and coating an article to be coated with the coating material, followed by drying, which process comprises

chemically bonding an ultraviolet absorptive compound having the maximum value of its light absorption spectrum in a wavelength region shorter than 380 nm and having a molecular extinction coefficient at the absorption maximum wavelength of 5,000 to 50,000 to either or both of the binder and the curing agent constituting the coating material,

preparing a coating material with the above-mentioned bonding and the constitution of the coating material being designed such that when the coating material is coated on an article and dried, the concentration C (mol/L) of the residual group of the ultraviolet absorptive-compound in the dry coating film may satisfy the expression

εdC≧129·logτ−367

wherein ε is the molecular extinction coefficient of the residual group of the above-mentioned compound in the dry film, d is the thickness (cm) of the dry coating film when in use and τ is the time (hour) of exposure in the accelerated weathering test that shows a gloss retention of 80% or more which is determined according to the requirements of intended uses, and

coating the coating material on the article, followed by drying, so that the thickness of the dry coated film may become the above-mentioned d, and a coating material which provides the film.

Provided are a process for producing a coating film excellent in such weather resistances as gloss retainability, resistance to discoloration and resistance to cracking necessary for long-term outdoor uses, and a coating material which gives the film.

### BACKGROUND OF THE INVENTION

This invention relates to a process for producing a coating film which can be used as protective coatings for houstop water-proofing, architectures such as floors and external walls of buildings, building materials, sports facilities such as tennis courts and athletic sports stadiums, as well as structures for display installed outdoors, such as road-signs, automobiles, domestic electric appliances, wood works, plastics moldings and printed matters, and further as surface coating materials for substances unstable to light and has excellent weather resistances required for long-term outdoor use such as gloss retainability, resistance to discoloration and resistance to cracking, and also to a coating material which can give the above-mentioned film.

As to a method for improving the weather resistance of coating materials, there have hitherto been known two-component coating compositions containing a compound having an ultraviolet absorbing ability (hereinafter referred to as ultraviolet absorptive compound) incorporated into the composition. Such coating compositions are excellent in weather resistance and, since they are of two-component system, can form coating film excellent in such physical properties as adhesiveness and coating film strength; so that they have been used as top coat for housetop water-proofing and external walls of buildings, building materials, sports facilities, and the like.

In particular, when an acrylic polyol is used as the binder of the coating material and an isocyanate prepolymer is used as the curing agent thereof, the resulting coating composition can form a coating film excellent in weather resistance, gloss, chemical property and mechanical strength, and has been generally used as a coating material for outdoor use. However, the above-mentioned coating composition has a shortcoming in that when the coating film obtained is used for a long period, a bleeding phenomenon, wherein the ultraviolet absorptive compound bleeds out to the surface, occurs and hence the beneficial effect of the compound does not last long.

To overcome the above-mentioned shortcoming, some attempts have been made to fix the ultraviolet absorptive compound into the coating composition, and a method has been proposed wherein a polymerizable ultraviolet absorptive compound is polymerized in an acrylic polyol (JP-A-9-3393).

As to the curing agent, further, a coating composition incorporated with a product obtained by bonding an ultraviolet absorptive compound into an isocyanate has been disclosed (JP-B-47-29199).

With regard to the ultraviolet absorptive compound in the coating material, however, attention has been attracted only to the amount of the compound incorporated into the coating material, and much remains unknown with respect to the relation of the ultraviolet absorbing abilities of the ultraviolet absorptive compound as molecular extinction coefficient and absorbing wavelength region with the weather resistance and the relation between the amount of the ultraviolet absorptive compound present in the coating film after coating and the weather resistance. Thus, though it is already known that the use of an expensive ultraviolet absorptive compound is effective, it is still unclear how to make efficient use of such a compound, and no suggestion has yet been made of a design technique which can control the weather resistance as desired.

### SUMMARY OF THE INVENTION

The object of this invention is to provide a process for producing a coating composition excellent in long-term weather resistances including gloss retainability and resistance to discoloration in long period outdoor use which comprises, in a two-component curable coating material, chemically bonding, an ultraviolet absorptive compound to the binder or the curing agent such that its ultraviolet absorbing ability is not impaired, to make the dry coating film after coating contain a specified amount of the compound. For this purpose, in this invention, the relation between the amount of an ultraviolet absorptive compound used and the weather resistance is examined, from which a design technique for obtaining weather resistance which meets the performance requirements of the coating material is obtained, and the above-mentioned process can be provided based on the design technique.

The present inventors have made extensive study on a process for producing a coating composition which can retain good weather resistance for a long period. As a result, the inventors have found out conditions for minimizing ultraviolet degradation by incorporating into a coating composition a product obtained by chemically bonding an ultraviolet absorptive compound to a binder or a curing agent so as to make the dry coating film after coating contain a specified amount of the compound, and resultantly succeeded in obtaining a coating film excellent in weather resistance. This invention has been thus accomplished.

According to this invention, there are provided a process for-producing a weather resistant coating film which can keep a gloss retention of 80% or more for 1000 hours or more in an accelerated weathering test by a carbon sunshine weather-o-meter by preparing a weather resistant coating material comprising a binder and a curing agent as main constituents and coating an article to be coated with the coating material, followed by drying, which process comprises

chemically bonding an ultraviolet absorptive compound having the maximum value of light absorption spectrum in a wavelength region shorter than 380 nm and having a molecular extinction coefficient at the absorption maximum wavelength of 5,000 to 50,000 to either or both of the binder and the curing agent constituting the coating material,

preparing a coating material with the above-mentioned bonding and constitution of the coating material being designed such that when the coating material is coated on an article and dried, the concentration C (mol/L) of the residual group of the ultraviolet absorptive compound in the dry coating film may satisfy the expression

εdC—≧129·logτ−367,

wherein ε is the molecular extinction coefficient of the residual group of the above-mentioned compound in the dry film, d is the thickness (cm) of the dry film when in use, and τ is the time (hr) of exposure in the accelerated weathering test that shows a gloss retention of 80% or more which is determined according to the requirements of intended uses, and

coating the coating material on the article, followed by drying, so that the thickness of the dry coated film may become the above-mentioned d, and a coating material which can provide the above-mentioned film.

### BRIEF DESCRIPTION OF THE DRAWING

FIG. 1 is a graph showing the ultraviolet transmittance of each coating film.

FIG. 2 shows the absorption spectrum of a functional group residue having ultraviolet absorbing ability.

FIG. 3 is a graph showing a relation between the amount of the functional group of an ultraviolet absorptive compound and the absorbance.

FIG. 4 is a graph showing a relation between absorbance and gloss retention.

FIG. 5 is a graph showing a relation between the amount of a functional group and gloss retention.

FIG. 6 is a graph showing a relation between absorbance and gloss retention.

FIG. 7 is a graph showing a relation between the amount of the functional group residue having ultraviolet absorbing ability in the coating film and the gloss retention.

FIG. 8 is a graph showing a relation between absorbance and weather resistance.

FIG. 9 is a graph showing a relation among the concentration and the molecular extinction coefficient of an ultraviolet absorptive compound residual group in the coating film, the thickness of dry coating film and the exposure time.

### DETAILED DESCRIPTION OF THE INVENTION

This invention is described in detail below.

In this invention, the ultraviolet absorptive compound having the maximum value of its light absorption spectrum in a wavelength region shorter than 380 nm and having a molecular extinction coefficient at the absorption maximum wavelength of 5,000 to 50,000 (said compound being hereinafter referred to simply as ultraviolet absorptive compound) is used singly or in a combination of two or more thereof and is bonded into the binder or the curing agent such that the ultraviolet absorbing ability of the ultraviolet absorptive compound may not be impaired, in other words, the compound may be bonded, through its group or moiety other than that having the ultraviolet absorbing ability, into the binder or the curing agent, and the group or moiety having the ultraviolet absorbing ability may remain unreacted or unchanged. In this invention, further, the-amount of the ultraviolet absorptive compound to be bonded is determined such that when the coating material is coated and dried the concentration C (mol/L) of the ultraviolet absorptive compound residual group in the dry coating film may satisfy the above-mentioned expression, and the constitution of the coating material, that is, the compounding amounts of the binder and the curing agent to which the ultraviolet absorptive compound has been bonded, is determined so as to satisfy the above-mentioned expression.

The ultraviolet absorptive compound used in this invention may be, for example, an ultraviolet absorptive compound having an active hydrogen and an ultraviolet absorptive compound having a polymerizable vinyl group.

The ultraviolet absorptive compound having an active hydrogen may be, for example, benzotriazole type compounds having an active hydrogen, such as 2-(2′-hydroxy-5′-methylphenyl)benzotriazole, 2-(2′-hydroxy-5′-t-butylphenyl)benzotriazole, 2-(2′-hydroxy-3′-t-butyl-5′-methylphenyl)-5-chlorobenzotriazole and 2-(2′-hydroxy-4′-octoxyphenyl)benzotriazole; and benzophenone type compounds having an active hydrogen, such as 2-hydroxy-4-octoxybenzophenone, 2-hydroxy-4-ethoxybenzophenone, 2-hydroxy-4-methoxybenzophenone, 2-hydroxy-4-octoxy-2′-chloro-benzophenone and 2-hydroxy -4-octoxy-3′-methyl-benzophenone; used each alone or in a combination thereof.

The ultraviolet absorptive compound having a polymerizable vinyl group may be, for example, benzotriazole type compounds having a vinyl group, such as 2-[2′-hydroxy-5′-(methacryloyloxymethyl)phenyl]-2H-benzotriazole, 2-[2′-hydroxy-5′-(methacryloyloxyethyl)-phenyl]-2H-benzotriazole, 2-[2′-hydroxy-5′-t-butyl-3′-(methacryloyloxyethyl)phenyl]-2H-benzotriazole and 2-[2′-hydroxy-5′-(methacryloyloxyethyl)phenyl]-5-chloro -2H-benzotriazole) and benzophenone type compounds having a vinyl group, such as 2-hydroxy-4-(3-acryloxy -2-hydroxypropoxy)benzophenone, 2-hydroxy-4-(3-methacryloxy-2-hydroxypropoxy)benzophenone and 2′-dihydroxy-4-(3-methacryloxy-2-hydroxypropoxy-benzophenone; used each alone or in a combination thereof.

For chemically bonding the ultraviolet absorptive compound to the binder or the curing agent in the coating material, it is preferable to polymerize an ultraviolet absorptive compound having a polymerizable vinyl group with another monomer and/or prepolymer each having a polymerizable vinyl group, or to make an ultraviolet absorptive compound having an active hydrogen react on an isocyanate prepolymer and/or isocyanate monomer each having at least two free isocyanate groups. By chemically bonding the ultraviolet absorptive compound to the binder or the curing agent in the coating material, coating film excellent in weather resistance can be provided. The most preferable method in using a binder or a curing agent to which an ultraviolet absorptive compound has been bonded is to use an acrylic polyol as the binder and, at the same time, to use a nonyellowing isocyanate as the curing agent.

More specifically, the ultraviolet absorptive compound having a polymerizable vinyl group, which is a constituent of the acrylic polyol (binder) to which the above-mentioned ultraviolet absorptive compound has been bonded, may be, for example, a benzotriazole type compound having a vinyl group, such as 2-[2′-hydroxy -5′-(methacryloyloxymethyl)phenyl]-2H-benzotriazole, 2-[2′-hydroxy-5′-(methacryloyloxyethyl)phenyl]-2H-benzotriazole, 2-[2′-hyroxy-5′-t-butyl-3′-(methacryloyloxyethyl)phenyl]-2H-benzotriazole and 2-[2′-hydroxy-5′-(methacryloyloxyethyl)phenyl]-5-chloro -2H-benzotriazole; and a benzophenone type compound having a vinyl group, such as 2-hydroxy-4-(3-acryloxy -2-hydroxypropoxy)benzophenone, 2-hydroxy-4-(3-methacryloxy-2-hydroxypropoxy)benzophenone and 2′-dihydroxy-4-(3-methacryloxy-2-hydroxypropoxy-benzophenone; used each alone or in a combination thereof.

The unsaturated monomer component having a hydroxyl group which serves as another constituent may be, for example, hydroxyethyl (meth)acrylate, hydroxypropyl (meth)acrylate and caprolactone-modified hydroxy (meth)acrylate, used each alone or in a combination thereof.

Another polymerizable monomer which is another constituent may be, for example, cyclohexyl(meth)acrylate, methylcyclohexyl acrylate, t-butylcyclohexyl(meth)acrylate, methyl(meth)acrylate, ethyl(meth)acrylate, propyl(meth)acrylate, isopropyl(meth)acrylate, butyl(meth)acrylate, isobutyl(meth)acrylate, sec-butyl(meth)acrylate, t-butyl (meth)acrylate, isopentyl(meth)acrylate, neopentyl(meth)acrylate, hexyl(meth)acrylate, heptyl(meth)acrylate, octyl(meth)acrylate, 2-ethylhexyl(meth)acrylate, stearyl(meth)acrylate, benzyl(meth)acrylate, dimethylaminomethyl acrylate, diethylaminomethyl acrylate, dibutylaminomethyl acrylate, dihexylaminomethyl acrylate, styrene, α-methylstyrene, vinyltoluene, vinylidene chloride, vinyl acetate, acrylic acid, maleic acid, itaconic acid, 2-acryloyloxyethylsuccinic acid and 2-acryloyloxyethyl-phthalic acid, used each alone or in a combination thereof.

As other constituents, there may be used, if necessary and desired, a light stabilizer, such as 4-(meth)acryloyloxy-2,2,6,6-tetramethylpiperidine, 4-(meth)acryloylamino-2,2,6,6-tetramethylpiperidine, 4-(meth)acryloyloxy-1,2,2,6,6-pentamethylpiperidine, and 4-(meth)acryloylamino-1,2,2,6,6-pentamethylpiperidine, each alone or in a combination thereof.

The method of polymerization used in copolymerizing the monomer composition comprising the above-mentioned constituents for preparing the binder is not particularly limited, but it is preferably solution polymerization.

The solvent used in the copolymerization may be, for example, aromatic hydrocarbons, such as toluene and xylene; ketones, such as acetone, methyl ethyl ketone and methyl isobutyl ketone; esters, such as ethyl acetate and butyl acetate; cellosolve acetate and propylene glycol monomethyl ether acetate; used each alone or in a combination thereof.

A polymerization initiator is used in copolymerizing the monomer composition. Polymerization initiators generally used are, for example, those of azo type, such as azobisisobutyronitrile, and those of peroxide type, such as benzoyl peroxide; which may be used each alone or in a combination thereof.

The ultraviolet absorptive compound having an active hydrogen which is a constituent of the curing agent to which the above-mentioned ultraviolet absorptive compound has been bonded may be, for example, a benzotriazole type compound, such as 2-(2′-hydroxy-5′-methylphenyl)benzotriazole, 2-(2′-hydroxy-5′-t-butylphenyl)benzotriazole, 2-(2′-hydroxy-3′-t-butyl-5′-methylphenyl)-5-chlorobenzotriazole and 2-(2′-hydroxy-4′-octoxyphenyl)benzotriazole; and a benzophenone type compound, such as 2-hydroxy-4-octoxybenzophenone, 2-hydroxy-4-ethoxybenzophenone, 2-hydroxy-4-methoxybenzophenone, 2-hydroxy-4-octoxy-2′-chlorobenzophenone and 2-hydroxy-4-octoxy-3′-methyl-benzophenone; used each alone or in a combination thereof.

The isocyanate compound used as another constituent may be, for example, nonyellowing isocyanates, such as hexamethylene diisocyanate, isophorone diisocyanate and cyclohexylmethane diisocyanate; their isocyanurates, biurets and trimelthylolpropane adducts; and the adducts thereof with compounds having an active hydrogen, such as amines, carboxylic acids, alcohols, and the derivatives thereof. They may be used each alone or in a combination thereof.

In reacting the isocyanate compound with the ultraviolet absorptive compound containing an active hydrogen, there may be added to these constituents a compound having an active hydrogen, e.g., amines, carboxylic acids, alcohols, and the derivatives thereof, each alone or in a combination thereof, whereby the chemical characteristics and the physical characteristics can be controlled as desired.

The solvents which may be used in reacting the ultraviolet absorptive compound with the isocyanate are, for example, aromatic ones, such as toluene and xylene, ketones, such as acetone, methyl ethyl ketone and methyl isobutyl ketone, esters, such as ethyl acetate, butyl acetate and isobutyl acetate, cellosolve acetate and propylene glycol monomethyl ether acetate; these may be used either singly or in a combination thereof. The use of solvents containing an active hydrogen, e.g., alcohols, should be avoided because such solvents react with isocyanates.

Urethane reaction catalysts may also be used to promote reaction. Such catalysts include, for example, organometallic catalysts, such as dibutyltin diacetate and dibutyltin dilaurate, and amine type catalysts, such as 1,4-diazabicyclo-(2,2,2)octane, triethylamine, N,N,N′,N′-tetramethylethylenediamine, triethylenediamine and dimethylaminoethanol. They may be used each alone or in a combination thereof.

Further, according to necessity, any desired isocyanate prepolymer may be mixed, examples of which include isocyanate monomers, such as hexamethylene diisocyanate and isophorone diisocyanate, isocyanurates, biurets, and adducts with a compound having an active hydrogen, such as amines, carboxylic acids, alcohols and the derivatives thereof; they may be used each alone or in a combination thereof.

The method of reaction is not particularly limited, and the reaction may be conducted according to conventional techniques. However, attention should be paid to conduct the reaction preferably by a method which avoids the presence of water. For example, the use of a urethane-grade solvent or the use of a desiccant is advisable. The desiccant which may be used is, for example, tosyl isocyanate, molecular sieve, etc. For obtaining a coating material particularly excellent in weather resistance and physical property in this invention, it is preferable to use isocyanurates or biurets of hexamethylene diisocyanate. In reacting the ultraviolet absorber with an isocyanate compound, it is preferable to design the reaction such that, on an average, two or more isocyanate groups per molecule remain in the isocyanate composition. When the number of the group is less than two on an average, in the succeeding reaction with the curing agent component the crosslinking tends to be insufficient, leading to unsatisfactory physical properties of the resulting coating material.

The coating material according to this invention may contain, according to necessity, a promoter for reaction with isocyanates, organic solvent, additive, inorganic pigment, organic pigment and body pigment. The reaction promoter may be, for example, organometallic catalysts, such as butyltin diacetate and dibutyltin dilaurate, and amine type catalysts, such as 1,4-diazabicyclo(2,2,2)octane, triethylamine, N,N,N′,N′-tetramethylethylenediamine, triethylene-diamine and dimethylaminoethanol, used each alone or in a combination thereof.

The organic solvent may be, for example, aromatic solvents, such as toluene and xylene; ketones, such as acetone, methyl ethyl ketone and methyl isobutyl ketone; esters, such as ethyl acetate and butyl acetate; cellosolve acetate and propylene glycol monomethyl ether acetate, used each alone or in a combination thereof.

The additive may be various conventional additives for coating materials, for example, antifoaming agents, dispersants, leveling agents, adhesion improving agent, plasticizers, stabilizers and sedimentation preventing agents, used each alone or in a combination thereof. The inorganic pigment may be, for example, titanium oxide, zinc white, lead yellow, red oxide, yellow iron oxide, iron black and carbon black. The organic pigment may be, for example, azo type compounds and phthalocyanine type compounds. The body pigment may be, for example, calcium carbonate, silicon oxide, clay, organic bentonite and silica rock powder. These pigments may be used each alone or in a combination thereof.

In this invention, to attain a sufficient weather resistance of the coating material, the amount of the functional group of the ultraviolet absorptive compound to be used is determined according to the exposure time that shows a gloss retention of 80% or more which is required by the intended coating film thickness and intended use of the coating such that when the coating material is coated and dried the concentration C (mol/L) of the residual group of the compound in the dry film may satisfy the empirical expression

εdC≧129·logτ−367

wherein ε is the molecular extinction coefficient of the said compound residual group in the dry coating film, d is the thickness (cm) of the dry film when in use and τ is the exposure time (hr) in an accelerated weathering test that shows a gloss retention of 80% or more which is required according to the intended use, whereby the object can be achieved.

The article which may be coated by the above-mentioned coating composition is not particularly limited. Articles to be coated include, for example, plastics, such as urethane, FRP (fiber reinforced plastics), polypropylene, polycarbonate and acrylic resins, wood, metal, glass and ceramics. Further, the coating composition may be used for surface protection of such chemical substances as pigments having insufficient weather resistance, protection of printed ink surfaces and surface coating of paper. By applying the coating composition of this invention to the surface of these coated articles, the long-term weather resistance of the coated articles can be recurred.

Thus, the coating composition of this invention can be widely used as a coating material for plastics moldings, domestic electric appliances, metal goods, automobiles, acroplanes, buildings, building materials, sports facilities and wood works.

This invention is described in detail below with reference to Examples and other examples.

### REFERENTIAL EXAMPLE 1

### (Method of Preparation of Ultraviolet Absorber-Containing Binder (Acrylic Polyol))

In a flask fitted with a stirrer, dropping funnel, cooling tube and thermometer were placed 10 parts by weight of butyl acetate and 10 parts by weight of xylene, then brought up to 120° C. in nitrogen atmosphere, and a polymerizable monomer mixture placed in the dropping funnel in the following composition was added by drops thereto at a constant rate in 2 hours:

| | |
|---|---|
| cyclohexyl methacrylate | 25 parts by weight |
| methyl methacrylate | 6 parts by weight |
| butyl acrylate | 10 parts by weight |
| 2-hydroxyethyl methacrylate | 7 parts by weight |
| acrylic acid | 0.3 part by weight |
| 2-[2′-hydroxy-5′- | 8 parts by weight |
| (methacryloyl)phenyl]- | |
| benzotriazole | |
| methacryloylamino-2,2,6,6- | 0.5 part by weight |
| tetramethylpiperidine | |
| azobisisobutyronitrile | 1 part by weight |

One hour after-completion of the dropwise addition, a mixed solution of 0.2 part by weight of azobisisobutyronitrile and 10 parts by weight of xylene was added by drops at a constant rate over 2 hours and, after completion of the dropwise addition, the resulting mixture was kept at 120° C. for 1 hour. After cooling, the reaction mixture was diluted with 17.5 parts by weight of xylene to obtain an acrylic polyol (binder) having a viscosity of 30,000 mPa•s, nonvolatile matter content of 56.3% and weight average molecular weight of 31,000.

### REFERENTIAL EXAMPLE 2

The same procedures as in Referential Example 1 were followed to conduct polymerization according to the following composition of polymerizable monomers.

| | |
|---|---|
| cyclohexyl methacrylate | 25 parts by weight |
| methyl methacrylate | 6 parts by weight |
| butyl acrylate | 10 parts by weight |
| 2-hydroxyethyl methacrylate | 7 parts by weight |
| acrylic acid | 0.3 part by weight |
| 2-[2′-hydroxy-5′-(methacryloyl)- | 5 parts by weight |
| phenyl]benzotriazole | |
| methacryloylamino-2,2,6,6-tetra- | 0.5 part by weight |
| methylpiperidine | |
| azobisisobutyronitrile | 1.2 part by weight |
| xylene | 37.5 parts by weight |
| butyl acetate | 10 parts by weight |

The acrylic polyol (binder) thus obtained had a viscosity of 13,100 mPa•s, nonvolatile matter content of 53.3% and weight average molecular weight of 32,000.

### CONTROL EXAMPLES 1 AND 2

Acrylic polyols (binders) were obtained according to the compositions shown in Table 1 by following the same procedures as in Referential Example 1.

TABLE 1
Composition and property of acrylic resin

| Control Example | | 1 | 2 |
|---|---|---|---|
| composition | Cyclohexyl methacrylate | 25 | 25 |
| | Methyl methacrylate | 6 | 6 |
| | Butyl acrylate | 10 | 10 |
| | 2-Hydroxyethyl methacryolate | 7 | 7 |
| | Acrylic acid | 0.3 | 0.3 |
| | 2-[2′-Hydroxy-5′-(methacryloyl)- | | 0.5 |
| | phenyl]benzotriazole | | |
| | Azobisisobutyronitrile | 1.2 | 1.2 |
| | Xylene | 35.5 | 35.5 |
| | Butyl acetate | 10 | 10 |
| property | Viscosity (mPa · s) | 2200 | 2350 |
| | Nonvolatile matter | 49 | 50 |
| | content (%) | | |
| | Molecular weight | 30000 | 31000 |
| | (weight average) | | |

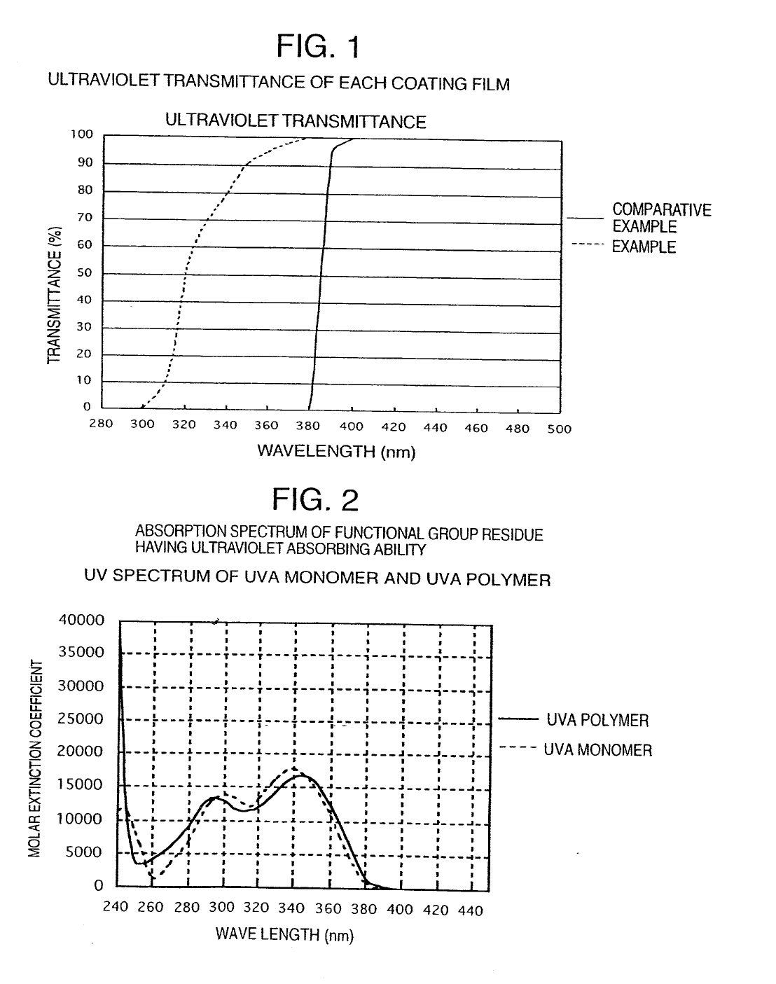

The acrylic polyol (binder) obtained in the Referential Example 1 and the acrylic polyol (binder) obtained in Control Example 1 were each formed into a coating film having a thickness of 100 μm after drying, which was then determined for its ultraviolet transmittance with an ultraviolet spectrophotometer. The results of the determination are shown in FIG. 1. FIG. 1 shows the ultraviolet transmittance of each coating film.

Further, the respective absorption spectra of the binder obtained in Referential Example 1 and the ultraviolet absorptive compound alone before bonding are shown in FIG. 2 each as a relation between the molecular extinction coefficient and the wavelength.

The determination was made as follows. For the binder, it was diluted with a spectrally unrelated resin (acrylic polyol described in Referential Example 1) to give a concentration of functional group residue, after bonding, in the coating film of 0.106 m mol/L and the absorbance was measured at a film thickness of 100 μm to obtain the molecular extinction coefficient. For the ultraviolet absorptive compound before bonding, determination was made by a solution method using a 1 cm cell at a concentration of 0.0619 m mol/L to obtain the molecular extinction coefficient in the same manner as above.

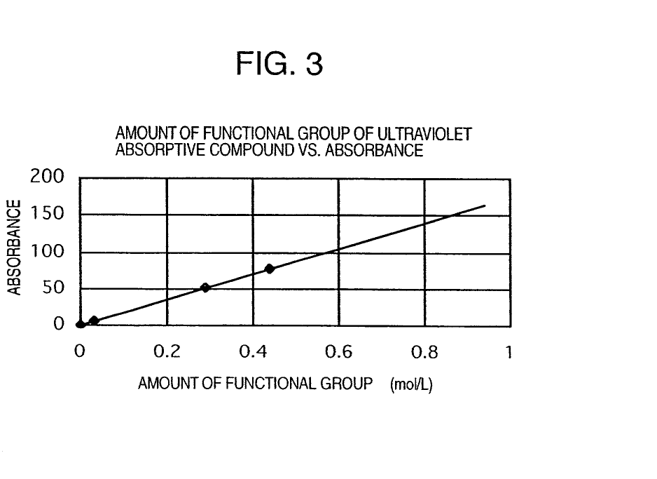

The binders obtained in Referential Examples 1 and 2 and the binders obtained in Control Examples 1 and 2 were each formed into a coating film having a thickness of 100 μm after drying, and the absorbances of the coating films were determined to examine the relation of the amount of the functional group of the ultraviolet absorptive compound per 1 cm² with the absorbance. When absorbance is designated A and transmittance is designated T, absorbance and transmittance are related by A=−logT. For absorbances of Referential Examples 1 and 2, determination was made with samples obtained by diluting the binders prepared in Referential Examples 1 and 2 with a binder having no ultraviolet absorbing ability to 20-fold dilution in terms of solid content, and the absorbances were obtained from the results of determination by calculation. The results thus obtained are shown in Table 2 and FIG. 3. Table 2 shows the relation of the amount of the functional group of the ultraviolet absorptive compound with the absorbance. FIG. 3 shows the relation of the amount of the functional group of the ultraviolet absorptive compound with the absorbance.

TABLE 2
Relation of amount of functional group of
ultraviolet absorptive compound with absorbance

| | Referential | Referential | Control | Control |
|---|---|---|---|---|
| | Example | Example | Example | Example |
| Specimen | 1 | 2 | 1 | 2 |
| Amount of | 0.44 | 0.29 | 0 | 0.032 |
| functional group | | | | |
| of ultraviolet | | | | |
| absorptive | | | | |
| compound (mol/L) | | | | |
| Absorbance | 77 | 51 | 0 | 5.5 |

### REFERENTIAL EXAMPLE 3

### (Method of Preparation of Ultraviolet Absorber-Containing Curing Agent (Isocyanate Prepolymer))

In a flask fitted with a stirrer, cooling tube and thermometer were placed 24 parts by weight of butyl acetate, 12 parts by weight of hexamethylene diisocyanurate, 2 parts by weight of 2(2′-hydroxy-5′-methylphenyl)benzotriazle and 0.01 part by weight of dibutyltin dilaurate, then brought up to 70° C. in nitrogen atmosphere and allowed to react for 3 hours. After the reaction mixture had been cooled to room temperature, 38 parts by weight of an isocyanate prepolymer (Acrit 8XA-012, a trade name, mfd. by TAISEI CHEMICAL INDUSTRIES, LTD.; nonvolatile matter content: 50%, isocyanate content: 3.1%) was added thereto to obtain an isocyanate prepolymer (curing agent) having a nonvolatile matter content of 43%, viscosity of 20 mPa•s and isocyanate group content of 4.3%.

### CONTROL EXAMPLE 3

In a flask fitted with a stirrer, cooling tube and thermometer were stirred 24 parts by weight of butyl acetate and 12 parts by weight of hexamethylene diisocyanurate in nitrogen atmosphere at room temperature for 10 minutes, and 38 parts of an isocyanate prepolymer (Acrit 8XA-012) was added thereto to obtain a composition. Thus, an isocyanate prepolymer with a nonvolatile matter content of 42%, viscosity of 18 mPa•s and isocyanate group content of 5.1% was obtained.

### REFERENTIAL EXAMPLE 4

Pigment dispersion was conducted by using a sand mill and by using the binder resins (acrylic polyols) obtained in Referential Examples 1 and 2 according to the following compositions, to obtain white coating materials.

| Mill base | |
|---|---|
| titanium oxide | 20 parts by weight |
| binder resin | 10 parts by weight |
| xylene | 5 parts by weight |
| total | 35 parts by weight |
| Let down | |
| mill base | 35 parts by weight |
| binder resin | 50 parts by weight |
| xylene | 15 parts by weight |
| total | 100 parts by weight |

### CONTROL EXAMPLE 4

In the same manner as in Referential Example 4 except for using the resins prepared in Control Examples 1 and 2, white coating materials were obtained.

### EXAMPLES 1 AND 2, COMPARATIVE EXAMPLES 1 AND 2

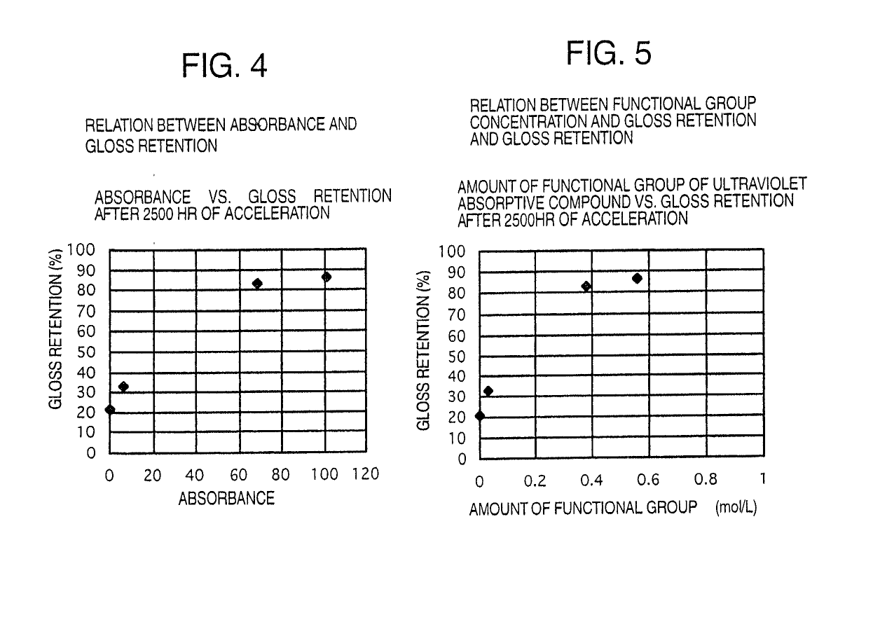

The white coating material of Referential Example 4 and the isocyanate prepolymer prepared in Referential Example 3, and the white coating material of Control Example 4 and the isocyanate prepolymers prepared in Control Example 3 were respectively compounded so as to give a ratio, NCO group/OH group, of 1/1. The resulting coating materials were each coated on an aluminum plate and dried to give a coating film having a thickness of 150 μm after drying, and subjected to an accelerated weathering test for 2500 hours in a carbon sunshine weather-o-meter to determine gloss retention and to examine, from the gloss retention of the respective coating material determined, the relation of absorbance with gloss retention and the relation of the amount of the functional group of the ultraviolet absorptive compound with gloss retention. The results thus obtained are shown in Table 3 and FIGS. 4 and 5. FIG. 4 shows the relation of absorbance with gloss retention (1), and FIG. 5 shows the relation of the amount of functional group with gloss retention (1).

TABLE 3
Composition of coating material and result of test

| | | | Compara- | Compara- |
|---|---|---|---|---|
| | | | tive | tive |
| | | | Example | Example |
| Specimen | Example 1 | Example 2 | 1 | 2 |
| Coating material | 100 | | | |
| obtained in | | | | |
| Referential Example | | | | |
| 4 (part by weight) | | | | |
| (Resin is that of | | | | |
| Referential Example | | | | |
| 1) | | | | |
| Coating material | | 100 | | |
| obtained in | | | | |
| Referential Example | | | | |
| 4 (part by weight) | | | | |
| (Resin is that of | | | | |
| Referential Example | | | | |
| 2) | | | | |
| Coating material | | | 100 | |
| obtained in Control | | | | |
| Example 4 (part by | | | | |
| weight) (Resin is | | | | |
| that of Control | | | | |
| Example 1) | | | | |
| Coating material | | | | 100 |
| obtained in | | | | |
| Comparative Example | | | | |
| 4 (parts by weight) | | | | |
| (Resin is that of | | | | |
| Control Example 2) | | | | |
| Isocyanate | 31.4 | 31.4 | | |
| prepolymer obtained | | | | |
| in Referential | | | | |
| Example 3 (part by | | | | |
| weight) | | | | |
| Isocyanate | | | 26.7 | 26.7 |
| prepolymer obtained | | | | |
| in Control Example 3 | | | | |
| (part by weight) | | | | |
| Amount of functional | 0.56 | 0.38 | 0 | 0.032 |
| group of ultraviolet | | | | |
| absorptive compound | | | | |
| (mol/L) | | | | |
| Absorbance | 100.8 | 68.4 | 0 | 5.8 |
| (Value determined | | | | |
| from FIG. 2) | | | | |
| Gloss retention | 86 | 83 | 21 | 33 |
| after 2500 hrs of | | | | |
| acceleration test in | | | | |
| weather-ometer (%) | | | | |

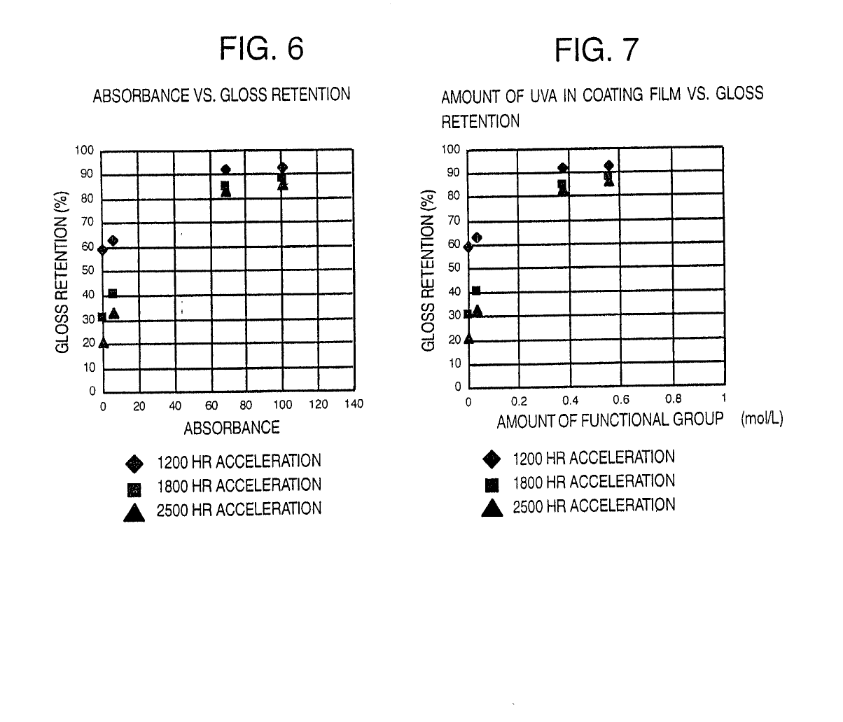

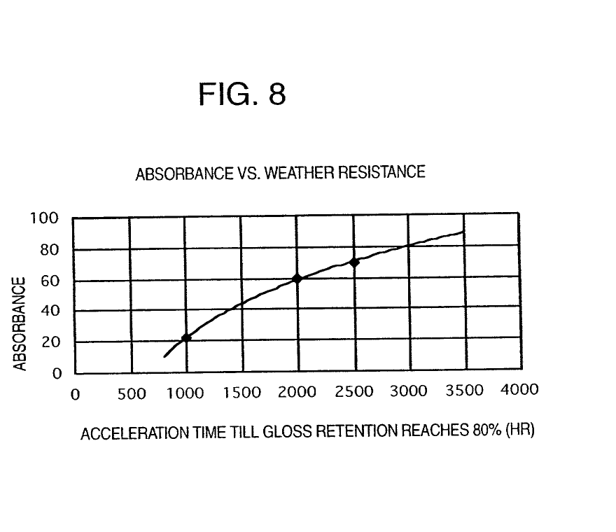

Next, based on the changes of gloss retention of respective coating materials, the points at which gloss retention reached 80% at respective absorbances and at respective amounts of the functional group of the ultraviolet absorptive compound were determined, from which the acceleration time at which gloss retention reaches 80% at any desired absorbance and at any desired amount of the functional group of the ultraviolet absorptive compound was determined. The results thus obtained are shown in Table 4 and FIGS. 6-9. FIG. 6 is a graph showing the relation of absorbance with gloss retention (2), FIG. 7 is a graph showing the relation of the amount of functional group with gloss retention (2) and FIG. 8 is a graph showing the relation of absorbance with weather resistance.

TABLE 4
Change of gloss retention of each coating material

| | | Amount of functional | | | | | |
|---|---|---|---|---|---|---|---|
| | | group of ultraviolet | Gloss retention (%) | | | | |
| | | absorptive compound | 500 | 1000 | 1500 | 2000 | 2500 |
| Specimen | Absorbance | (mol/L) | hrs | hrs | hrs | hrs | hrs |
| Example 1 | 100.8 | 0.56 | 97 | 93 | 91 | 88 | 86 |
| Example 2 | 68.4 | 0.38 | 97 | 92 | 88 | 85 | 83 |
| Comparative | 0 | 0 | 79 | 59 | 44 | 31 | 21 |
| Example 1 | | | | | | | |
| Comparative | 5.8 | 0.032 | 85 | 63 | 50 | 41 | 33 |
| Example 2 | | | | | | | |

It can been seen that in the group wherein the coating composition obtained by the method of Example 1 is used the weather resistance is improved when the amount of the functional group of the ultraviolet absorptive compound is increased. It can be seen further that when the amount of functional group is 0.38 mol/L, a gloss retention of 80% can be maintained at an acceleration time of 2500 hours, and thus an excellent weather resistance is attained.

To obtain, from the relation shown in FIG. 8, an empirical rule for estimating the value of absorbance at which 80% gloss retention can be attained at an exposure time τ determined for intended purposes, the relation of εdC, namely absorbance, with log τ was plotted as a graph.

As a result, it has been revealed that the relation shows a good linearity and can be used as an empirical formula for determining C. Thus, the concentration C (mol/L) of the residual group of the ultraviolet absorptive compound to be present in the dry film when the coating material is coated and dried can be determined by the expression.

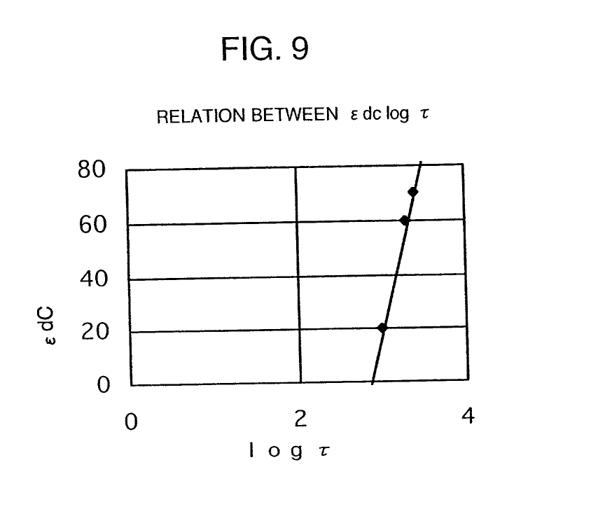

εdC≧129·logτ−367

wherein ε is the molecular extinction coefficient of the said compound residual group in the dry film, d is the thickness (cm) of the dry coating film when in use and τ is the exposure time (hr) in the accelerated weathering test that shows a gloss retention of 80% or more which is determined according to the requirements of intended uses. This expression is shown by FIG. 9.

According to this invention, coating film improved in long-term weather resistance can be obtained without causing deterioration of physical and chemical properties of the film by bonding an ultraviolet absorptive compound to the binder or the curing agent of the coating material skillfully so that the ultraviolet absorbing ability may not be impaired, thereby to make the dry coating film after drying contain a specific amount of a functional group having ultraviolet absorbing ability. This invention can be applied to such uses as coating materials and inks wherein great importance is attached to weather resistance.

According to this invention, the time during which a coating film maintain a gloss retention of 80% or more in an accelerated test by a carbon sunshine weather-o-meter can be easily lengthened according to the intended use; thus, for example, a long-term weather resistance of 2500 hours or more can be attained.

1. A process for producing a weather resistant coating film which can keep a gloss retention of 80% or more for 1,000 hours or more in an accelerated weathering test by a carbon sunshine weather-o-meter by preparing a weather resistant coating material comprising a binder and a curing agent as main constituents and coating an article to be coated with the coating material, followed by drying, which process comprises
chemically bonding an ultraviolet absorptive compound having the maximum value of its light absorption spectrum in a wavelength region shorter than 380 nm and having a molecular extinction coefficient at the absorption maximum wavelength of 5,000 to 50,000 to either or both of the binder and the curing agent constituting the coating material,
preparing a coating material with the above-mentioned bonding and the constitution of the coating material being designed such that when the coating material is coated on an article and dried, the concentration C (mol/L) of the residual group of the ultraviolet absorptive compound in the dry coating film may satisfy the expression
εdC≧129·logτ−367
wherein ε is the molecular extinction coefficient of the residual group of the above-mentioned compound in the dry film, d is the thickness (cm) of the dry film when in use, and τ is the time (hour) of exposure in the accelerated weathering test that shows a gloss retention of 80% or more which is determined according to the requirements of intended uses, and
coating the coating material on the article, followed by drying, so that the thickness of the dry coated film may become the above-mentioned d.

2. The process according to claim 1 wherein the binder to which the said compound has been bonded is a resin obtained by copolymerizing an ultraviolet absorptive compound having a polymerizable vinyl group with another monomer having a polymerizable vinyl group.

3. The process according to claim 1 wherein the curing agent to which the said compound has been bonded is a curing agent which comprises as an essential constituent an isocyanate compound containing residual isocyanate groups obtained by reacting an ultraviolet absorptive compound having an active hydrogen with a part of the isocyanate groups of an isocyanate prepolymer and/or monomer each having at least two free isocyanate groups and further comprises, according to necessity, an isocyanate prepolymer.

4. The process according to claim 1 wherein the ultraviolet absorptive compound is at least one compound selected from the group consisting of benzotriazole type compounds and benzophenone type compounds.

5. A weather resistant coating material which comprises a binder and a curing agent as main constituents and, when coated on an article to be coated and dried, can give a weather resistant coating film which can keep a gloss retention of 80% or more for 1000 hours or more in an accelerated weathering test by a carbon sunshine weather-o-meter, which is obtained by chemically bonding an ultraviolet absorptive compound having the maximum value of its light absorption spectrum in a wavelength region shorter than 380 nm and having a molecular extinction coefficient at the absorption maximum wavelength of 5,000 to 50,000 to either or both of the binder and the curing agent constituting the coating material with the above-mentioned bonding and constitution being designed such that when the coating material is coated on an article and dried, the concentration C (mol/L) of the residual group of the ultraviolet absorptive compound in the dry coating film may satisfy the expression
εdC≧129·logτ−367
wherein ε is the molecular extinction coefficient of the residual group of the above-mentioned compound in the dry film, d is the thickness (cm) of the dry film when in use, and τ is the time (hour) of exposure in the accelerated weathering test that shows a gloss retention of 80% or more which is determined according to the requirements of intended uses.
